(19) United States
(12) Patent Application Publication
(10) Pub. No.: US 2009/0289921 A1
(43) Pub. Date: Nov. 26, 2009

(54) COMMUNICATIONS-ENABLED DISPLAY CONSOLE

(75) Inventors: Matthew David Mickelson, Bothell, WA (US); J. David Egner, Sammamish, WA (US); Bernard Schultz, Edmonds, WA (US); Manolito E. Adan, Woodinville, WA (US); Daniel B. Phillips, Bellevue, WA (US); Glade Bandley Bacon, Everett, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/125,922

(22) Filed: May 23, 2008

(51) Int. Cl. G06F 3/042; G09G 3/00

(52) U.S. Cl. 345/176; 345/173; 345/32

(57) ABSTRACT

The display console includes a substrate having a viewing surface and a hidden surface. The display console further includes a display zone, a border zone, and a transceiver module configured to wirelessly send and receive data and coupled to the hidden surface of the substrate in the border zone. The display console further includes a hardware interface operatively coupled to the transceiver module, and configured to provide an image to the display zone.

### BACKGROUND

There is significant interest today in integrating functionally disparate computer components to enhance usability, robustness, and aesthetic appeal. The strung-together assembly of computer components so common in the past is now giving way to more elegant, self-contained, and physically integrated computer systems.

A central feature of many computer systems is the display console, which also has undergone a significant evolution in recent years. Cathode-ray tubes, once state-of-the-art, are now largely replaced by sleek, liquid-crystal, plasma, and projection-based displays. Some displays include input functionality as well: light-pen and touch-screen functionality, for example. Further integration of the display console with other functional components may present novel, non-obvious, and unexpected advantages for the user.

### SUMMARY

Thus, in one embodiment, a communications-enabled display console is provided. The display console includes a substrate having a viewing surface and a hidden surface opposite the viewing surface. The display console further includes a display zone, a border zone bordering the display zone, and a transceiver module coupled to the hidden surface of the substrate in the border zone, and configured to wirelessly send and receive data. The display console further includes a hardware interface operatively coupled to the transceiver module, and configured to provide an image to the display zone.

Other embodiments disclosed herein elaborate on a range of display zone options, transceiver plurality options, transceiver mounting options, and contemplated advantages related to each.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a cross-sectional view of a communications-enabled, interactive display console in accordance with an embodiment of the present disclosure.

FIG. 2 is a plan view of a communications-enabled, interactive display console in accordance with an embodiment of the present disclosure.

FIG. 3 shows a snap bracket configured to retain a transceiver module within a recessed pocket of a communications-enabled, interactive display console in accordance with an embodiment of the present disclosure.

### DETAILED DESCRIPTION

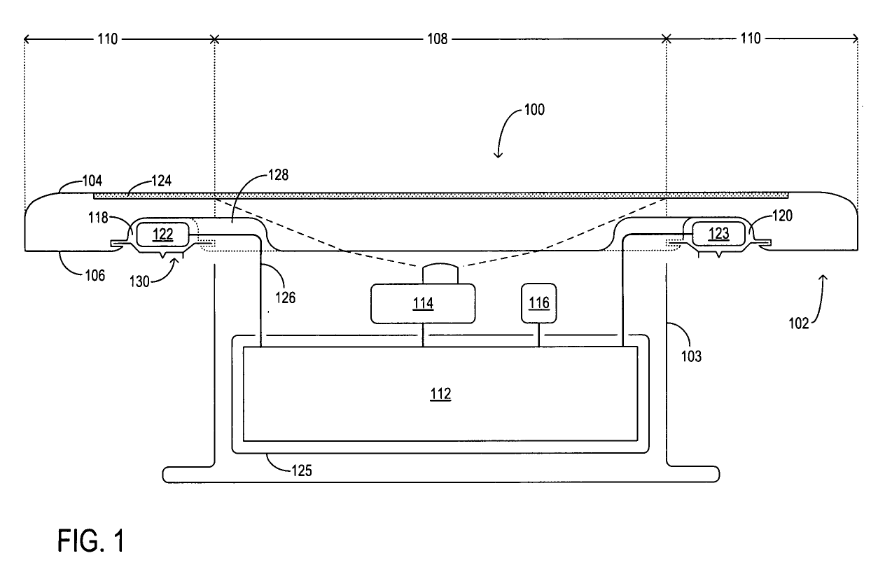

FIG. 1 is a cross-sectional view of a communications-enabled, interactive display console. In the illustrated embodiment, console 100 includes substrate 102 and pedestal 103 secured to the substrate. Substrate 102 may be a monolith or may otherwise be composed of different layers or sections joined together. The substrate as a whole presents a viewing surface 104 and a hidden surface 106 opposite the viewing surface.

A user may approach the console in such a way as to view an image displayed on the viewing surface, the hidden surface being eclipsed by the viewing surface and in that sense hidden from the user's view. In the illustrated embodiment, regions of the hidden surface and components mounted thereon remain readily accessible for servicing. In other embodiments, however, the pedestal may extend substantially to the edge of the substrate, thereby restricting access to the hidden surface.

In the illustrated embodiment, console 100 is oriented for placement on a horizontal surface such as a floor, with pedestal 103 resting on the horizontal surface. In this orientation, a user may view the viewing surface from above the console. In other embodiments, the console may be oriented vertically or at an oblique angle with respect to the horizontal, such that a user may view the viewing surface from a front side of the console.

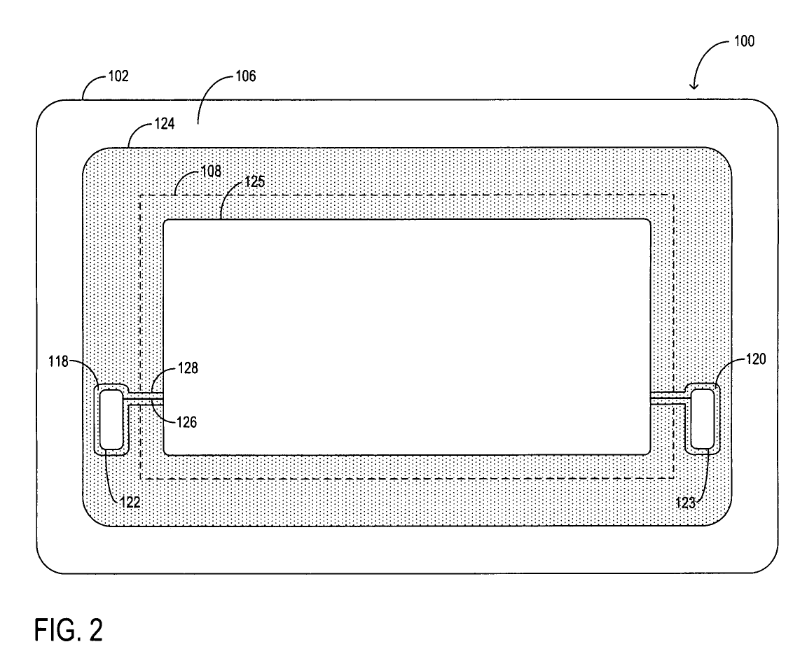

FIG. 2 shows the same communications-enabled, interactive display console, but viewed from below, i.e., toward hidden surface 106, and with pedestal 103 omitted for clarity.

In the illustrated embodiment, substrate 102 is divided functionally into two zones: display zone 108 and border zone 110. Display zone 108 is a zone or region of the substrate used to display an image, just as a stand-alone computer monitor or display screen is used to display an image. Border zone 110 is a zone or region of the same substrate that borders the display zone.

Substrate 102 may be fabricated from a sheet of material by cutting and machining. In an alternative, substrate 102 may be fabricated by molding a material precursor (e.g., a pre-polymerized mixture) inside a form. Should the substrate be composed of different sections, those sections may be fabricated as described above, then joined by press fitting, by using an adhesive, or by other suitable methods. In some embodiments, substrate 102 may be made of acrylic, polycarbonate, and/or other transparent, substantially transparent, or translucent polymer materials (including also glass), so that an image provided to the display zone via hidden surface 106 may show through to viewing surface 104.

In this example, the distinction between the display zone and the border zone is purely functional, as display zone 108 and border zone 110 define different geometric regions of the same physical structure. In other examples, the display zone may differ materially from the border zone: it may be formed from a different material or formed from the same or different materials but structured differently. In other examples, there may be a seam or junction between the display zone and the border zone.

In the illustrated embodiment, display zone 108 is rectangular, and border zone 110 frames the display zone on all four sides. In other embodiments, the display zone may have virtually any shape, and the border zone may border the display zone along any part of the perimeter of that shape.

FIG. 1 shows hardware interface 112, projector 114, and infrared camera 116 schematically. Hardware interface 112 may include, in one non-limiting example, a computer: it may contain a power supply, one or more processors, volatile and/or non-volatile memory, and input/output interface devices. Hardware interface 112 may further include, encoded in volatile or non-volatile memory, an operating system and one or more software applications to enable a user to interact with the console. In some examples, the hardware interface may include an application-specific integrated circuit (ASIC), or custom chip, to support operating-system or application functionality. In other examples, equally consistent with this disclosure, hardware interface 112 may include more or less functionality. Its configuration may be that of a terminal client, providing only the rudimentary input/output interface capability to service the input and output devices included within the console. In such examples, processing and application-serving functionality may be enabled remotely, i.e., from a device or network not contained within the console. Further, it should be understood that hardware interface 112, though rendered in FIG. 1 as a single, structureless object, may comprise a plurality of component groupings distributed throughout console 100.

In the illustrated embodiment, projector 114 is configured to project an image onto hidden surface 106 and through display zone 108 so that the image is rendered correctly on viewing surface 104. To enable the projection of the image, hardware interface 112 is operatively coupled to projector 114 and configured to provide the image thereto.

Infrared camera 116 is configured to detect a perturbed reflection of infrared light from hidden surface 106 as may be caused by an object (e.g., a finger, a cell phone, a glass of beer) being placed on viewing surface 104. In this embodiment, placing, removing, or manipulating objects on the viewing surface are examples of user input. To register the user input at console 100, infrared camera 116 is operatively coupled to hardware interface 112. In the illustrated embodiment, infrared camera 116 is configured to detect a perturbed reflection of infrared light from hidden surface 106 of the substrate in display zone 108 of the substrate. Display zone 108 is thereby configured to be a touch-sensitive display zone. To further enable the touch-sensitive aspect of display zone 108, console 100 may advantageously include an infrared source such as an infrared light-emitting diode (IR-LED) source, as well as additional infrared cameras at different locations within the console (not shown in the drawings).

It should be understood that the illustrated embodiment is but one of many contemplated approaches by which a display zone or a touch-sensitive display zone may be configured on a substrate. Other embodiments may employ liquid-crystal, plasma, and/or optically transparent conductor technologies, as examples. In particular, capacitive and/or electromagnetic touch sensing may be enabled by including an optically transparent conductor grid in the display zone. In these embodiments as well, display and user-input sensitive components may be operatively coupled to a hardware interface.

In other embodiments equally consistent with this disclosure, touch-sensitive functionality in the display zone may be limited or entirely absent. A user may interact with the console by using a keyboard, a mouse, a game controller, a joystick, and/or a microphone, as examples, or by using any suitable user input device.

In the illustrated embodiment, hidden surface 106 of the substrate defines first and second recessed pockets 118 and 120, both disposed in border zone 110. Recessed pockets 118 and 120 may be included in the hidden surface of the substrate in any suitable manner, such as by machining. Alternatively, the recessed pockets may be formed in the hidden surface by molding a precursor of the substrate or section of the substrate into a form that includes features complementary to the recessed pockets. In one non-limiting example, those features may themselves include the objects intended to be placed within the recessed pockets.

FIGS. 1 and 2 show first transceiver module 122 mounted within first recessed pocket 118 and second transceiver module 123 mounted within second recessed pocket 120. In some embodiments, each of the first and second recessed pockets may be deep enough so that the transceiver modules thus mounted are themselves recessed into hidden surface 106. In other embodiments, one or both of the transceiver modules may be flush with, or even protrude from, the hidden surface.

In the illustrated embodiment, each of first and second transceiver modules 122 and 123 are operatively coupled to hardware interface 112. Each of the first and second transceiver modules may be any device used to wirelessly send and receive data. As an example, each module may be a device configured to send and receive data over a microwave band. Further, one or both of the first and second transceiver modules, the hardware interface, and associated cabling may be configured for solderless replacement of either or both transceiver modules. In that way, the communications capability of the console may be updated as wireless technology progresses, or in the event of module failure, but with minimal hardware reconfiguration.

In one example, first transceiver module 122 is an IEEE 802.11x compliant (Wi-Fi®) module having a universal serial bus (USB) interface, and second transceiver module 123 is an IEEE 802.15.1 compliant (Bluetooth®) module also having a USB interface. This particular example is one of many in which the first and second transceiver modules send and receive data on overlapping wavelength bands, i.e., the first transceiver sends and receives data over a first wavelength band, the second transceiver sends and receives data over a second wavelength band, and the first and second wavelength bands overlap. In this example, the wavelength bands of the first and second transceiver modules are centered at ca. 12.5 centimeters (cm), corresponding to a frequency of 2.4 gigahertz.

In the illustrated example, it is advantageous that first transceiver module 122 and second transceiver module 123 be spaced apart from each other, advantageously by a distance greater than any wavelength used to send and receive data, viz., any wavelength in the first or second wavelength bands. In that way, each transceiver module is located outside of a so-called near field of the other. Such spacing, provided to reduce an interference of one transceiver module on the other, may be accomplished by locating first and second transceiver modules in border zone 110 of the substrate and on opposite sides of display zone 108, as illustrated in FIGS. 1 and 2. In other embodiments, adequate spacing may be provided by locating first and second transceiver modules in a border zone and on different, but not opposite, sides of the display zone.

It should be understood that other embodiments equally consistent with this disclosure may lack first recessed pocket 118, second recessed pocket 120, or both. One or more transceiver modules may nevertheless be mounted to a hidden surface of the substrate and on different sides of the display zone.

It should further be understood that some embodiments may include only one transceiver module. Even in these embodiments, locating the transceiver module on a hidden surface and in a border zone of the substrate may be advantageous. For instance, by locating the transceiver module in a border zone instead of a display zone, the transceiver module may avoid shadowing or obscuring an image displayed in the display zone. Further, by mounting the transceiver module to the hidden surface instead of the viewing surface, the transceiver module (which may be aesthetically inconsistent with the display presentation intended for the user) may be concealed from the user's view when the user views the viewing surface. Further still, the transceiver module located as described hereinabove may be physically protected from the user as the user interacts with the viewing surface of the substrate. Finally, it should be understood that Wi-Fi® and Bluetooth® are but two of the many contemplated wireless communications modes contemplated herein. Other modes fully consistent with this disclosure include Zigbee®, ISM band, various RF formats, etc.

In embodiments in which the substrate is transparent in the border zone, further concealment of the transceiver module may be provided via an optically diffusing layer at or adjacent the viewing surface. Thus, in FIGS. 1 and 2, optically diffusing layer 124 is provided at viewing surface 104. Optically diffusing layer 124 covers the border zone of the substrate and extends into the display zone as well. In one example, the optically diffusing layer may be etched into the viewing surface of the substrate and then overmolded with another material to provide a smooth finish.

Besides providing concealment, locating a transceiver module in a border zone may help to reduce interference between the transceiver module and a communications-enabled user device (e.g., a cell phone or a personal-digital assistant) placed on the viewing surface and in the display zone. Thus, by deliberate placement of the transceiver module, the console may be configured to permit a wireless communication to or from a user device placed on the viewing surface and in the display zone. Moreover, locating the transceiver module in the border zone may, in some example configurations, extend its operating range, as described below.

The illustrated embodiment of FIGS. 1 and 2 further includes electromagnetic-radiation attenuating shield 125, enclosing some or all of hardware interface 112 and configured to limit an escape of electromagnetic radiation therefrom. Thus, to enable reception and transmission of an electromagnetic signal from transceiver modules 122 and 123, these modules are located outside of shield 125 in the illustrated example. To increase a range of reception and transmission from either module, however, the module may be spaced relatively far from the shield, the operating wavelengths of the transceiver defining a natural length scale for the configuration. Thus, a signal at a given wavelength may be attenuated when the shield is comparable or larger in size than the wavelength, and when the distance between the transceiver module and the shield is comparable or shorter than the wavelength. In other words, to limit attenuation by a shield that is large compared to the near field of the transceiver module, the shield should penetrate the near field as little as possible.

A detailed analysis of wave-propagation patterns may recommend an optimum position of first transceiver module 122 relative to shield 125, but in many examples, the principle outlined above is believed to be sufficient. Thus, in FIGS. 1 and 2, shield 125 is placed outside the near field of transceiver module 122, assuming a median operating wavelength of 12.5 cm. Equivalently, the shield is separated from the transceiver module by more than a median wavelength in the wavelength band over which the transceiver sends and receives data. In other embodiments, however, design constraints may bring the shield to within a near field of a transceiver module, such embodiments remaining fully consistent with this disclosure.

In the illustrated embodiment, operational coupling between first transceiver module 122 and hardware interface 112 is provided via first cable 126. First cable 126 includes one or more conductors or optical fibers configured to carry data between the hardware interface and the first transceiver module. Advantageously, the configuration of the hardware interface and of the first transceiver module is such that first cable 126 carries carrier-wave demodulated data, i.e., data that has been stripped from a carrier signal and includes less high-frequency power density than the carrier signal. It should be understood, however, that the data carried by first cable 126 may be packetized. Thus, first transceiver module 122 may further be configured to parse the carrier-wave demodulated data into digital data according to a data packet protocol. In some embodiments, first transceiver module 122 may be further configured to transmit the packetized digital data to a network stack in an operating system of hardware interface 112.

In some embodiments, first cable 126 may be a USB cable. The USB cable may impart generality to the operational coupling, allowing hardware interface 112 to couple with different USB-interfaced transceiver modules, present and future. Further, the USB cable may carry data at a frequencies of a computer serial bus instead of a microwave antenna (vide supra). Thus, capacitive and inductive losses of signal transmission, along with shielding requirements in the cable, are reduced.

FIGS. 1 and 2 also show first groove 128, formed in the hidden surface of substrate 102 and configured to marshal cable 126 en route from first transceiver 122 to hardware interface 112. First groove 128 may be formed in the hidden surface by machining or by molding, as examples.

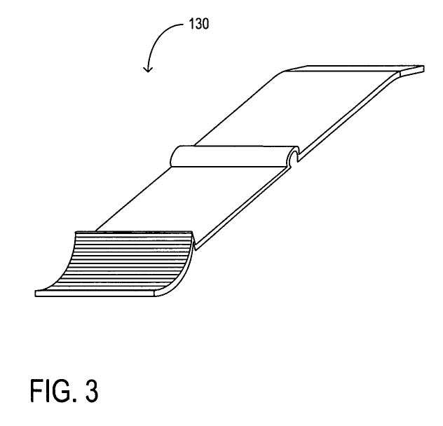

FIG. 1 shows first snap bracket 130 configured to retain first transceiver module 122 within first recessed pocket 118. First snap bracket 130 is a thin strip of resilient material bent or formed into a shape that amplifies its resiliency in a longitudinal direction. Thus, first snap bracket 130 is designed to be pressed into the first recessed pocket after the first transceiver module is mounted in the pocket. The first snap bracket is compressed upon entering the pocket and re-expands when fully inserted, thereby preventing the first transceiver module from falling out of the pocket. A more detailed view of snap bracket 130 is provided in FIG. 3.

In other embodiments, a bracket that is not a snap bracket may be used to retain a transceiver module within a recessed pocket, or otherwise to secure it to a hidden surface of the substrate. Such brackets may be secured to the hidden surface using fasteners: screws and washers, for example. In still other embodiments, an adhesive, a hook-and-loop adhesion material, and/or another suitable mounting mechanism may be used instead of a bracket to secure one or more transceiver modules to the hidden surface of the substrate.

It should be understood that embodiments such as the one illustrated in FIGS. 1 and 2, which include a second transceiver in addition to the first, may further include a second cable, a second groove, and a second snap bracket, that may be substantially the same or at least partly different than the first cable, first groove, and first snap bracket, respectively.

It should further be understood that the configurations and/or approaches described herein are exemplary in nature, and that these specific embodiments or examples are not to be considered in a limiting sense, because numerous variations are contemplated. Accordingly, the subject matter of the present disclosure includes all novel and non-obvious combinations and sub-combinations of the configurations and approaches disclosed herein, as well as any and all equivalents thereof.

1. A communications-enabled, interactive display console, comprising:
a substrate having a viewing surface and a hidden surface opposite the viewing surface, and including a touch-sensitive display zone and a border zone bordering the touch-sensitive display zone;
a transceiver module coupled to the hidden surface of the substrate in the border zone, and configured to wirelessly send and receive data; and
a hardware interface operatively coupled to the transceiver module, and configured to register a user input from, and to provide an image to, the touch-sensitive display zone.

2. The interactive display console of claim 1, further comprising a projector operatively coupled to the hardware interface and configured to project the image onto the hidden surface of substrate and through the touch-sensitive display zone.

3. The interactive display console of claim 1, wherein the substrate further includes an optically diffusing layer at or adjacent the viewing surface and configured to conceal the transceiver module.

4. The interactive display console of claim 1, wherein some or all of the hardware interface is enclosed in an electromagnetic-radiation attenuating shield, and the transceiver module is located outside of the shield.

5. The interactive display console of claim 4, wherein the transceiver module sends and receives data over a wavelength band, and the shield is separated from the transceiver module by more than a median wavelength in the wavelength band.

6. The interactive display console of claim 1 further configured for solderless replacement of the transceiver module.

7. The interactive display console of claim 1, wherein the substrate includes a transparent, substantially transparent, or translucent polymer material.

8. The interactive display console of claim 1, further configured to permit a wireless communication to or from a user device placed on the viewing surface and in the display zone.

9. A communications-enabled display console, comprising:
a substrate having a viewing surface and a hidden surface opposite the viewing surface, and including a display zone and a border zone bordering the display zone, the hidden surface defining, in the border zone, a pocket;
a transceiver module mounted in the pocket and configured to wirelessly send and receive data; and
a hardware interface operatively coupled to the transceiver module, and configured to provide an image to the display zone.

10. The display console of claim 9, further comprising a bracket configured to retain the transceiver module within the pocket.

11. The display console of claim 10, wherein the bracket is a snap bracket formed from a resilient material.

12. The display console of claim 9, further comprising a cable configured to carry data between the transceiver module and the hardware interface.

13. The display console of claim 12, the hidden surface of the substrate further including a groove configured to marshal the cable en route from the transceiver module to the hardware interface.

14. The display console of claim 12, wherein the cable carries carrier-wave demodulated data.

15. The display console of claim 12, wherein the cable is a universal serial bus cable.

16. A communications-enabled, interactive display console, comprising:
a substrate having a viewing surface and a hidden surface opposite the viewing surface, and including a touch-sensitive display zone and a border zone bordering the touch-sensitive display zone;
first and second transceiver modules coupled to the hidden surface of the substrate in the border zone, located on different sides of the touch-sensitive display zone, and configured to wirelessly send and receive data; and
a hardware interface operatively coupled to the first and second transceiver modules, and configured to register a user input from, and to provide an image to, the touch-sensitive display zone.

17. The interactive display console of claim 16, wherein the first transceiver sends and receives data over a first wavelength band, and the second transceiver sends and receives data over a second wavelength band overlapping the first wavelength band.

18. The interactive display console of claim 17, wherein the first and second transceiver modules are separated by more than one wavelength in the first or second wavelength band.

19. The interactive display console of claim 16, wherein the first transceiver module is an IEEE 802.11x compliant module.

20. The interactive display console of claim 16, wherein the second transceiver module is an IEEE 802.15.1 compliant module.
